(19) United States
(12) Patent Application Publication
(10) Pub. No.: US 2003/0111401 A1
(43) Pub. Date: Jun. 19, 2003

(54) Water treatment plan: two-stage filtration

(76) Inventor: Skender Cocoli, Falls Church, VA (US)

Correspondence Address: Skender Cocoli, 7754 New Providence Dr. #22, Falls Church, VA, 22042-4497, US

(21) Appl. No.: 10/021,750

(22) Filed: Dec. 17, 2001

(51) Int. Cl. B01D 24/20

(52) U.S. Cl. 210/264; 210/275

(57) ABSTRACT

A water treatment plant with two-stage filtration for purification of surface water sources with low turbidity and low temperature. The flow rate of this integrated water treatment should be less than 2 m³/sec (≈46 mgd). The integrated two-stage filtration plant with one flash mixer, six roughing filters, with upward flow, six high rate dual media filters, with downwards flow, and a clearwell is recommended for surface water sources with turbidity less than 100 NTU, color less than 75 UC, coliform less than 20,000/100 mL, algae less than 2,000 ASU/mL, TOC less than 4 mg/L, iron less than 1.5 mg/L, taste and odor less than 5 TON, alkalinity less than 200 mg/L, hardness less than 150 mg/L. For maximum values of alkalinity and hardness given above, and for optimal value of pH, the color has to be less than 40 UC, when alum is to be used. Filter effluent turbidities are foreseen to be 0.1 NTU or less. Based on physical, chemical, microbiological and radiological data and the results of turbidity evaluation of surface waters by bench-scale tests (the standards jar tests) water quality parameters given above can be modified. In this water treatment plant the flow and water temperature changes are controlled hydraulically. Conceptually, six roughing filters and six high-rate dual media filters are self-backwashing with controlled backwash rate.

REFERENCES

| | | | |
|---|---|---|---|
| 4,152,262 | May, 1979 | Rose | 210/136 |
| 4,248,713 | February, 1981 | Meier | 210/232 |
| 4,331,542 | May, 1982 | Emrie | 210/794 |
| 4,377,485 | March, 1983 | Krofta | 210/704 |
| 4,441,997 | April, 1984 | Fields | 210/266 |
| 4,468,320 | August, 1984 | Schmidt | 210/97 |
| 4,482,461 | November, 1884 | Hindnab, et. al. | 210/741 |
| 5,520,804 | May, 1996 | Ward | 210/189 |
| 5,582,772 | December, 1996 | Wachinski, et. al. | 210/189 |
| 5,804,062 | September, 1998 | Wyness | 210/86 |
| 5,902,488 | May, 1999 | Prince | 210/747 |
| 5,997,750 | December, 1999 | Rozelle, et. al. | 210/744 |
| 6,013,181 | January, 2000 | Thellmann | 210/266 |

### OTHER REFERENCES CONSULTED

American Society of Civil Engineers and American Water Works Association. Water Treatment Plant Design. 2nd Edition, McGraw-Hill Publishing Co., New York, New York, 1990.

American Water Works Association. Water Quality and Treatment. 1990.

Amirtharajah, A. “Optimum Backwashing of Sand Filters.” Journal of Environmental Engineering Division, American Society of Civil Engineers (ASCE), Vol. 104, no. 5, October 1978.

Arboleda V. J. “Hydraulic Control Systems of Constant and Declining Flow Rate in Filtration.” Journal of AWWA, vol. 69, no. 2, February 1974.

Baylis, J. R. “Review of Filter Design and Methods of Washing.” Journal of AWWA, vol. 51, no. 11, November 1959.

Bollinger, K. A. “Water Treatment Plant Design is Flexible.” Water and Sewage Works, Apr. 30, 1974.

Cleasby, J. L. “Declining—Rate Filtration.” AWWA Journal. Vol. 73, no. 9, September 1981.

Cleasby, J. L. Arboleda, J.; Burns, D. E.; Prendiville, P. W; Savage, E. S. “Backwashing of Granular Filters.” Journal of AWWA, Vol. 69, no. 11, November 1977.

Cleasby, J. L. Di Bernardo, L. “Hydraulic Considerations in Declining Rate Filtration.”Journal of Environmental Engineering Division, ASCE, 1980.

Cleasby, J. L. Filter Rate Control Without Rate Controllers. Journal of AWWA, Vol. 61, no. 4, April 1969.

Cleasby, J. L. Williamson, M. W.; Baumann, E. R. “Effect of Filtration Rate Changes on Quality.” Journal of AWWA, Vol. 60, no. 4, p. 869, April 1968.

Cleasby, J. L., and Baumann, E. R. “Selection of Sand Filtration Rates.” Journal of AWWA, Vol. 54, no. 5, p. 579, May 1962.

Committee Report: Comparison of Alternative Systems for Controlling Flow Through Filters, AWWA Journal, vol. 76, no. 1, January 1984.

Culp, R. L. “Direct Filtration.” AWWA Journal, Vol. 69, no. 7, July 1977.

Davis, S. N.; DeWiest, R. J. M. Hydrology. John Wiley & Sons, Inc., New York, 1966.

Degremont. Water Treatment Handbook, Vol. 1 and Vol. 2, 6th edition. Lavoisier Publishing, Paris, France 1991.

Droste, R. L. Theory and Practice of Water and Wastewater Treatment. John Wiley and Sons, Inc. New York, N.Y., 1997.

Fair, G. M. and Geyer, J. C.; Okun, D. A. “Water and Waste Water Engineering.” Vol. 1. John Wiley & Sons, New York, N.Y., 1968.

Fair, G. M.; Geyer, J. C.; Okun, D. A. “Water and Waste Water Engineering.” Vol. 2. John Wiley & Sons, New York, N.Y., 1968.

Fox, D. M.; Cleasby, J. L. “Experimental Evaluation of Sand Filtration Theory.” Journal of Sanitary Engineering Division, ASCE, SA 5, October 1966.

Heertjes, P. M.; Lerk, C. F. “The Function of Deep Bed Filters.” Institute of Chemical Engineering, T129, 1967.

Herzig, J. P.; LeClerc, D. M.; Le Goff, P. “Flow of Suspensions Through Porous Media—Application to Deep Bed Filtration.” Industrial Engineering Chemistry, 8, August 1970.

Hsuing, K.; Cleasby, J. L. “Prediction of Filter Performance.” Journal of Sanitary Engineering Division, ASCE, December 1968.

Huang, J Y. C.; Baumann, E. R. “Least Cost Sand Filter Design for Iron Removal.”Journal of Sanitary Engineering Division, ASCE, SA 2, April 1971.

Hudson, E. H. Water Clarification Processes. Van Nostrand Reinhold Co., New York, N.Y., 1981.

Hudson, E. H., Jr. “Physical Aspects of Filtration.” Journal of AWWA, Vol. 61, no. 3, March 1969.

Hutchison, W. R.; Foley, P. D. “High-Rate Direct Filtration.” Journal of AWWA, Vol. 68, no. 6, June 1976.

Hutchison, W. R.; Foley, P. D. “Operational and Experimental Results of Direct Filtration.” Journal of AWWA, Vol. 66, no. 2, February 1974.

Ives, K. J. “Rapid Filtration.” Water Resources, Vol. 4, 1970.

Ives, K. J. “Simplified Rational Analysis of Filter Behavior.” Proceedings of Institute of Civil Engineering, Vol. 25, 1963.

Ives, K. J. “Theory of Filtration.” International Water Supply Association, London, vol. 1, 1969.

Ives, K. J. Sholji, I. “Research on Variables Affecting Filtration.” Journal of Sanitary Engineering Division, ASCE, SA 4, August 1965.

Joshi, N. S., etc. Up and Downflow Filtration for Iron Removal from Groundwater. Department of Environmental Engineering, Copenhagen, Denmark, 1988.

Kawamura, S. Design and Operation of High Rate Filters, I, II, III, Journal of AWWA, October, November, December 1975.

Kawamura, S. Integrated Design of Water Treatment Facilities. John Wiley and Sons, Inc. New York, N.Y., 1991.

Leva, M. Fluidization. McGraw-Hill Books Co., New York, N.Y., 1959

McGhee, T. J. Water Supply and Sewerage. 6th Edition, McGraw-Hill Publishing Company, New York, N.Y., 1991.

Montgomery, J. M. Consulting Engineers, Inc. Water Treatment Principles and Design. John Wiley and Sons, New York, N.Y., 1985.

Sakthivadival, R.; Thanikachalam, V.; Seetharaman, S. “Head-Loss Theories in Filtration.” Journal of AWWA, Vol. 64, no. 2, February 1972.

Sanks, R. L. Water Treatment Plant Design. Ann Arbor Science Publishers, Ann Arbor, Mich., 1982.

Saravanamuthu, V.; Ami, R. B. Overview of Deep Bed Filtration: Different Types and Mathematical Models for Water, Wastewater, and Sludge Filtration. CRC Press, Inc., Boca Raton, Fla., 1989.

Viessman, W. Jr.; Hammer, M. J. Water Supply and Pollution Control. 5th edition. Harper Collins, New York, N.Y., 1993.

Vigneswaran, S.; Aim, R. B. Overview of Deep Bed Filtration: Different Types and Mathematical Models for Water, Wastewater and Sludge Filtration. CRC Press Inc., Boca Raton, Fla., 1989.

Yao, K. M. “Water and Wastewater Filtration: Concepts and Applications.”

Environmental Science and Technology, Vol. 5, 1971.

### BACKGROUND OF THE INVENTION

The present invention relates to a water treatment plant with two-stage high-rate filtration, composed of flash mixer, roughing filters and dual media high-rate filters.

The first stage of filtration process can be realized as a contact flocculator/contact clarifier using deep coarse granular media with upward flow, and the second stage will be realized through dual media high-rate filters. The roughing filters will realize the flocculation process and the removal of 50-75% of the suspended matter. The two-stage filtration water treatment presented in this document is an optimal solution, conceptually original, for raw waters with turbidity less than 100 NTU, color less than 75 UC, coliform less than 20,000/100 mL, algae less than 2,000 ASU/ml, TOC less than 4 mg/L, iron less than 1.5 mg/L, taste and odor less than 5 TON, alkalinity less than 150 mg/L. Based on physical, chemical, microbiological and radiological data and the results of evaluation of treatibility of surface water sources during bench-scale tests (the standard jar test) water quality parameters given above can be changed. For this two-stage filtration water treatment plant, pilot plant studies are not recommended. In some instances may be very useful to temporarily realize an auxiliary flocculation process inside the plenum of roughing filters for a very short period of time, 3-5 minutes with high mixing intensity, G=100-300 I/sec. The two-stage filtration water treatment plant can be adjusted for these situations.

For coarse sand filters is recommended to use water backwashing simultaneously with air scour. The water backwash rate should be well below the fluidization velocity of the granular media. After simultaneous usage of water backwash and airflow, the water backwash will continue for a short period of time with rate below the fluidization velocity. For roughing filters this method is very effective. Water Quality and Treatment (Fourth Edition) maintains: “For coarser sand of 2.00 mm ES, airflow rates are increased to 6-8 scfm/ft² (110 to 150 m/h) with simultaneous water flow rates of 6 to 8 gpm/ft² (15-20 m/h).” Usually, for deep coarse sand filters is not recommended to use backwash troughs. During simultaneous air and water washing without expansion the surface crust of granular media (silica sand) is broken up by the air and the deep coarse sand bed remains stable. Rinsing is recommended with backwashing rate not less than 15 m/h. To increase the efficiency of removing dirty materials from the surface of filter, it is recommended to realize a horizontal water flow over the top of granular media.

Water Treatment Plant Design (Third Edition, p. 168) maintains: “Concurrent air scour and water wash is generally limited to the deep, coarse—grained filters common in Europe. For 1 to 2 mm E.S. media, air-scour rates of 2 to 4 ft³/min/ft² (0.6 to 1.2 m³/min/m²) are used with a water flow of 6.3 gpm/ft² (15.4 m/h). For 2 to 6 E.S. media, 6 to 8 ft³/min/ft² (15.4 to 18.3 m/h) are used . . . . The rate of final water wash is generally one to two times that used with air scour.”

The first stage of filtration should be realized by roughing deep coarse sand bed filters with upward filtration flow. This method offers a higher storing capacity but the head loss is limited by the weight of silica sand. When the head loss is greater than the weight of granular media, the sand will be pushed upward. To avoid lifting of silica sand, the head loss should be controlled through granular media or by installing a blocking grid.

Granular media of roughing filters should be supported by gravel layers graded from coarse on the top. Depending upon the plant flow rate (Q_{max.day}) the underdrain system of roughing filters should be with or without air cushion devices. For air cushion devices, stemmed nozzles should be used. The underdrain system without stemmed nozzles for distribution of air should be realized with distribution pipes with orifices (laterals+distribution main) on the true floor of the filter and special nozzles installed on the false bottom for distribution of mixed fluids (air+water).

The roughing filters with coarse silica sand 2-6 mm E.S. should be at the same time a contact flocculator. The mean values of velocity gradient in granular media during filter run should be within the range of 50-400 1/sec and detention time should be 3-5 min. Supplied air for concurrent air scour and waterwash should be sufficient for washing process. Distribution system for supplied air should be flexible to supply air when aeration of raw water is required and for some situations—with very low turbidity—to maintain in plenum a value of velocity gradient 100-300 1/sec. The calculation of mean value of velocity gradient for t=10° C. in plenum volume or air-sour rates for G=100-350 1/sec should be calculated with the following formula:

$$G = 18 \cdot \sqrt{\frac{{q}_{a} \cdot A \cdot H}{h}} … [ 1 \text{/} sec ] \qquad ( 1 )$$

where

qₐ=air-scour rate, [ft³/min/ft]

A=filter surface area, [ft²]

H=height of water from overflow weir to inlet orifice of air, [ft]

h=height of plenum, [ft]

For turbulent flow Rₑ>1000 and t=10° C. the rise velocity of air bubbles should be calculated with the following formula:

$$v = 57 \cdot \sqrt{d} \qquad ( 2 )$$

where

d=bubble diameter, [cm] greater than 0.35 cm

V=the rise velocity of air bubble, [cm/sec]

The bubble residence time can be calculated by the following formula:

$$t = \frac{h}{v} \qquad ( 3 )$$

The maximum permissible value of head loss in granular media of roughing filter can be calculated with the following formula:

$${h}_{f} = l \cdot ( 1 - p ) \cdot ( {γ}_{s} - {γ}_{w} ) \qquad ( 4 )$$

where

h_{f}=maximum permissible value of head loss in granular media, [m]

I=depth of granular media, [m]

p=porosity

γ_{S}=specific gravity of water, [gr/cm³]

γ_{W}=specific gravity of water, [gr/cm³]

The maximum value of velocity gradient in roughing filter bed at the end of filter run should be calculated with the following formula:

$$G = 45.55 \sqrt{\frac{{V}_{f}}{p} \cdot \frac{{h}_{f}}{l}} \qquad ( 5 )$$

where

V_{f}=rate of filtration, [m/h]

The minimum value of velocity gradient in roughing filter bed would be at the beginning of the filter run. The value of head loss in clean granular media for t=20° C. and for Rₑ<6 is recommended to be calculated by following formula:

$$\frac{{h}_{{o}_{f}}}{l} = 0.00051 \cdot ( \frac{{V}_{f}}{10} ) \cdot b \cdot ( \frac{0.6 {d}_{max} + 0.4 {d}_{min}}{{d}_{min} \cdot {d}_{60} \cdot {d}_{max}} ) \cdot {k}_{t} \qquad ( 6 )$$

where

$$\frac{{h}_{{o}_{f}}}{l} = hydraulic gradient$$

h_{O}_{_{f}}=head loss in clean granular media, [m]

I=depth of granular media, [m]

$$\begin{matrix}{V}_{f} = filtration velocity , [ \frac{{m}^{3}}{{h}_{r}} \cdot \frac{1}{{m}^{2}} ] \\ b = 0.006 \cdot \frac{1}{{p}_{o}^{8.29}} only for silica sand\end{matrix}$$

pₒ=0.29143·Ψ+0.2, only for silica sand

pₒ=porosity of clean media

Ψ=sphericity

dₘₐₓ·d₆₀·dₘᵢₙ=maximum sieve size, the sieve size which permits 60% by weight to pass, and minimum sieve size, [cm], respectively

kₜ≅1.56−0.028·t , coefficient of correction for different temperatures

t=water temperature ° C.

The residence time in granular media can be calculated by the following formula:

$$T = \frac{p}{{V}_{f}} \cdot l \qquad ( 7 )$$

For Reynolds number Rₑ>6, head loss for a clean bed should be calculated by Ergun equation. For coarse silica sand roughing filters the simultaneous air+water backwash is e very recommended method for cleaning process of granular media.

Water Quality and Treatment (Fourth Edition) maintains: “ . . . To prevent the loss of sand, the water and airflow rates are varied appropriately for the size of the sand, and the vertical distance from the sand surface to the washwater overflow should be at least 1.6 ft (0.5 m). Backwash troughs are not generally used, and the dirty wash water exits over a horizontal concrete wall. The top edge of the horizontal wall is sloped 45° downward toward the filter bed so that any sand grains that fall on the sloping wall during backwashing will roll back into filter bed . . . (p. 519). When air sour is to be delivered through the supporting gravel, great danger exists that the gravel will be disrupted during the backwash cycle, especially if air and water are used simultaneously. Two solutions are being used . . . . The other is to use a double reverse-graded gravel system graded from coarse on the bottom to fine in the middle and back up to coarse on the top . . . (p. 475).”

The underdrain system is false floor type with nozzles. Nozzles should have coarse openings ¼″ (6 mm) and equipped with a stem with required length, into plenum. Roughing filters should be realize as a deep coarse silica sand bed with effective size d₁₀=2−6 mm, uniformity coefficient smaller or equal to 1.5, and filtration rate 20-40 m/h. The bed depth should be fixed based on maximum available value of head loss h_{fm}/I during filter run and maximum value of velocity gradient at the end of filter run. The value of ratio h_{fm}/I in any case should be less than 1. As a general recommendation, the value of bed depth should be 1-2.5 m.

### BRIEF SUMMARY OF THE INVENTION

The present invention relates to a two-stage filtration water treatment plant, for purification of surface water sources with low turbidity. This two-stage filtration plant, conceptually original is an optimal solution, integrating in one block one flash mixer, six roughing filters, six high-rate dual media filters and one clearwell. The water temperature and flow changes in this water treatment plant with two-stage filtration are kept under control.

The two-stage filtration plant given in this document is recommended for flow plant Qₚ up to 2 m³/sec and for surface water sources with turbidity less than 100 NTU, color less than 75 CU, coliform less than 20,000/100 mL, algae less than 2,000 ASU/ml, TOC less than 4 mg/L, iron less than 1.5 mg/L, taste and odor less than 5 TON, alkalinity less than 200 mg/L, hardness less than 150 mg/L. For maximum values of alkalinity and hardness, given above, and for optimal value of pH, the color has to be less than 40 UC, when alum is to be used. Filter effluent turbidities are foreseen to be 0.1 NTU or less.

Flash mixing should be realized using the hydrodynamical dispersive flash mixed by pressured water-jets, with seven nozzles—six for hydrodynamical dispersion of coagulant and one for injection of chemical solution (alum), based on countercurrent principle. This flash mixer can be integrated with liquid chemical feed system, with metering pumps, according to four alternatives:

Alternative 1: Alum solution should be prepared with 15% strength and should be discharged upstream the injection nozzle for a second dilution. Alternative 2: Alum solution with strength 1% to 15% should be prepared in liquid chemical feed system maintaining constant the flow after second dilution and by metering pump will be discharged upstream of the injection nozzle. Alternative 3: Alum solution with strength from 1% to 15% should be prepared in liquid chemical feed system, and by metering pump will be discharged upstream of the injection nozzle, but the flow after second dilution will not be constant. Alternative 4: From liquid chemical storage of commercial liquid alum, that contains 5.4 lb dry alum per gallon, is taken the required flow and by metering pump 1 is discharged upstream the injection nozzle where the dilution occurs with 15% strength with filtered water from flash mixing system.

Flocculation process should be realized in the first-stage of filtration. The first-stage of filtration can be realized by roughing filters to accomplish flocculation and remove 50-75% of the suspended matter, and by contact clarifier also to accomplish flocculation and remove up to 90%-95% of the suspended matter. Roughing filter should be realized by deep coarse silica sand bed with effective size 2-6 mm and uniformity coefficient less than 1.5. Filtration rate 20-40 m/h with upward flow and the bed depth 1-2.5 m. Granular medium of roughing filters should be washed by raw water backwash simultaneously with air scour, backwash rate up to 55 m/h and air scour rate up to 115 m/h. For roughing filter, that should be used for this treatment plant it is not recommended to have backwash troughs. The underdrain system is false bottom type with nozzles. Nozzles should have coarse openings (5-6) mm with or without stem into plenum.

First-stage filtration, as an upward flow unit, could be also realized as a contact clarifier, with deep coarse silica sand bed, with effective size 1-2 and uniformity coefficient less than 1.5, filtration rate 10-30 m/h and the bed depth 1-2 m. Granular media should be washed by water backwash simultaneously with air scour—backwash rate up to 55 m/h and air scour rate up to 55 m/h. Also, for contact clarifier, it is not recommended to use backwash troughs. The underdrain system is false bottom type with nozzles. Nozzles should have coarse opening 5-6 mm with or without stem into plenum.

The second-stage filtration should be realized through high-rate dual media self-backwashing filter with controlled rate of backwashing, into the pipe of waste washwater. These filters should be washed with filtered water of other filters and surface washing system. Dual media beds contain silica sand and crushed anthracite coal, as a downward flow unit. Filtration rates 10-15 m/h, are effective values for dual media filters, selected for this treatment plant. The backwashing process will be carried out with high-rate backwash water and fixed surface wash system with water jets, for auxiliary scour.

The underdrain system of these filters, with much lower head loss than conventional filters, makes possible backwash velocities low enough to have fairly uniform water distribution and to have an effective backwashing process. The waste washwater from first and second stage of filtration, by gravity should be discharged into holding tank, volume of which should be equal to flow plant for one hour. Than water will overflow by pumps into sedimentation tank. The holding tank and sedimentation tank should be integrated in a circular basin. The effluent of sedimentation tank disinfected is than pumped into influent pipe at the head of plant. When the settleability of suspended matter of waste washwater is unacceptable for the above solution, it is recommended to use conventional flocculation and sedimentation as a pretreatment unit.

### BRIEF DESCRIPTION OF THE SEVERAL VIEWS OF THE DRAWINGS

The present invention is illustrated by the embodiments shown in the drawings, in which:

FIG. 1 is the plan, schematic representation of two-stage filtration water treatment plant 1 for purification of surface water sources with turbidities less than 100 NTU, as an optimal solution, in which are integrated flash mixing 3, six roughing filters 21, as first stage filtration, six high-rate dual media self-backwashing filters, 22 as second stage filtration, and the clear well 33.

FIG. 2 is a schematic representation of a cross-section of FIG. 1, through A-A.

FIG. 3 is a schematic representation, of cross-sections of FIG. 2 through B-B.

FIG. 4 is a schematic representation of a cross-section of FIG. 2 through C-C.

### DETAILED DESCRIPTION OF THE INVENTION

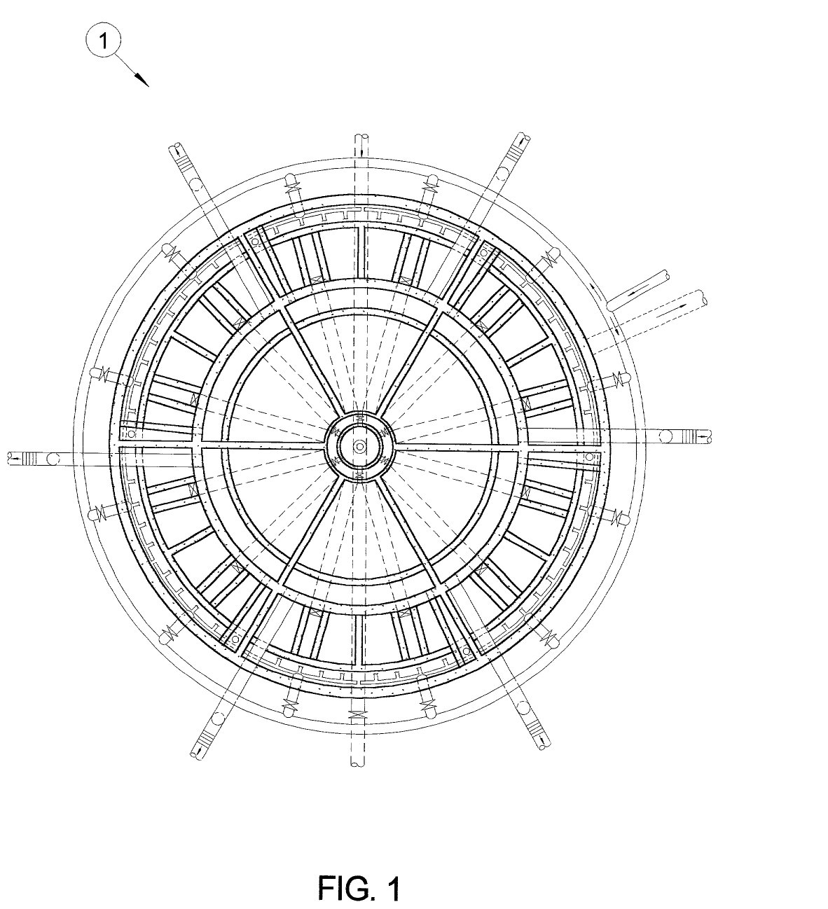

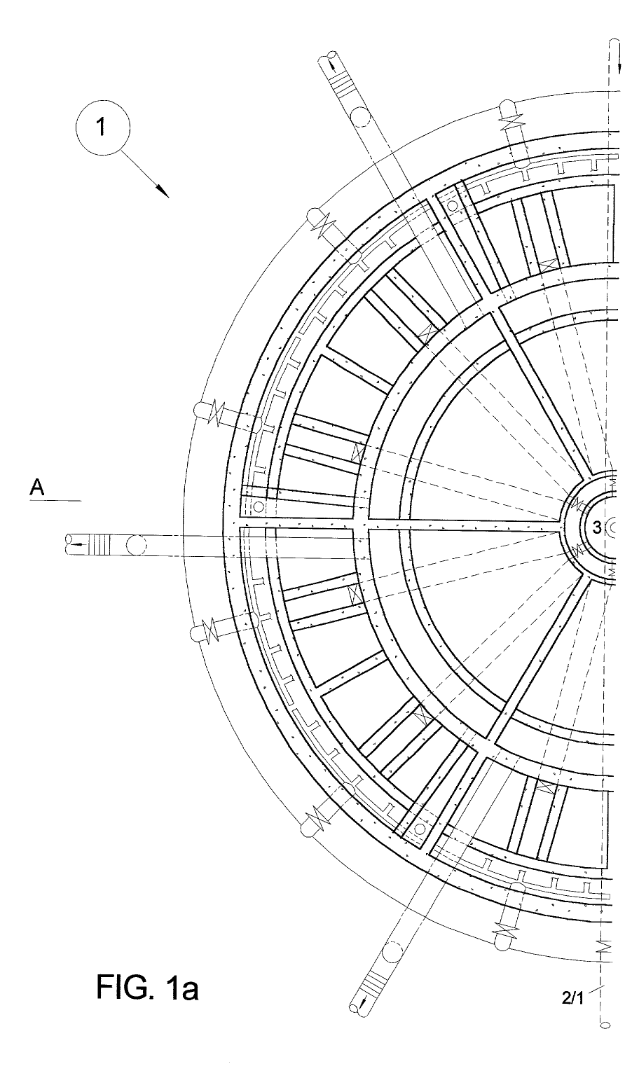

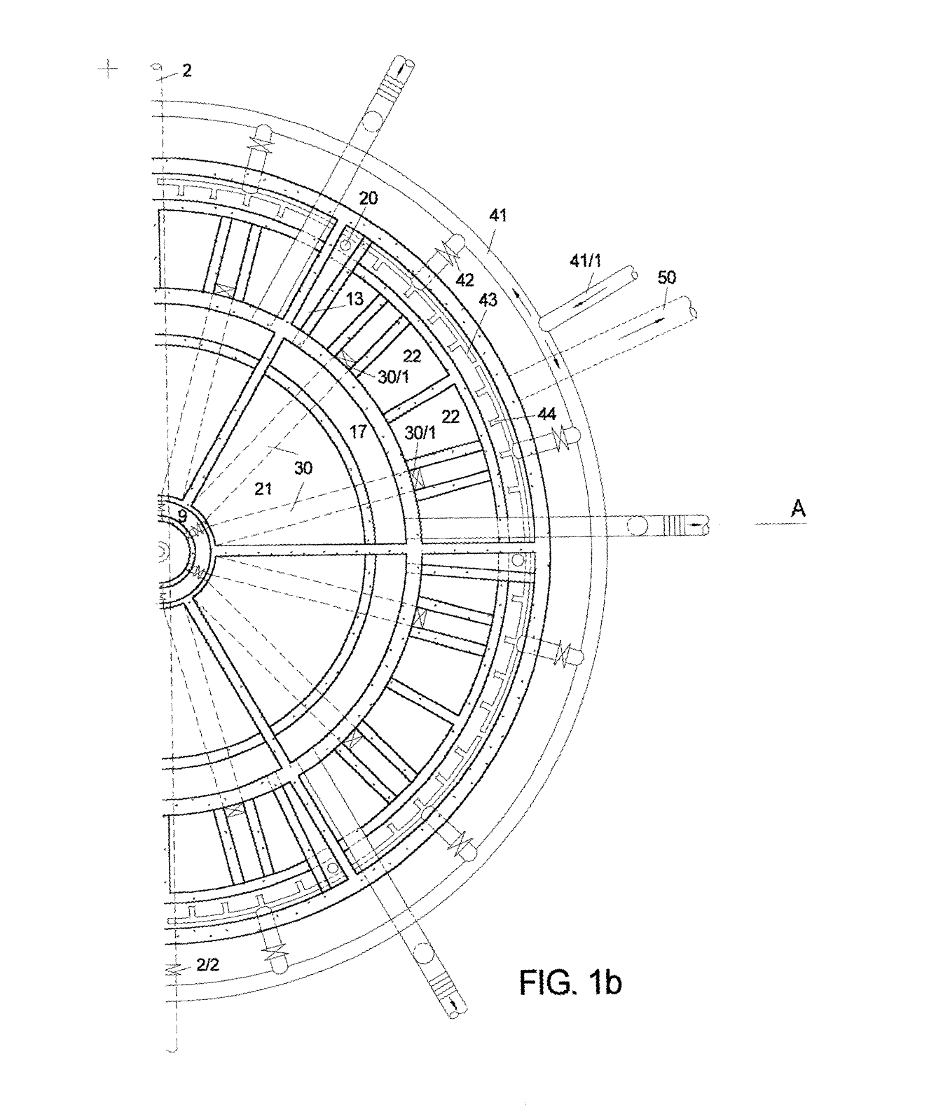

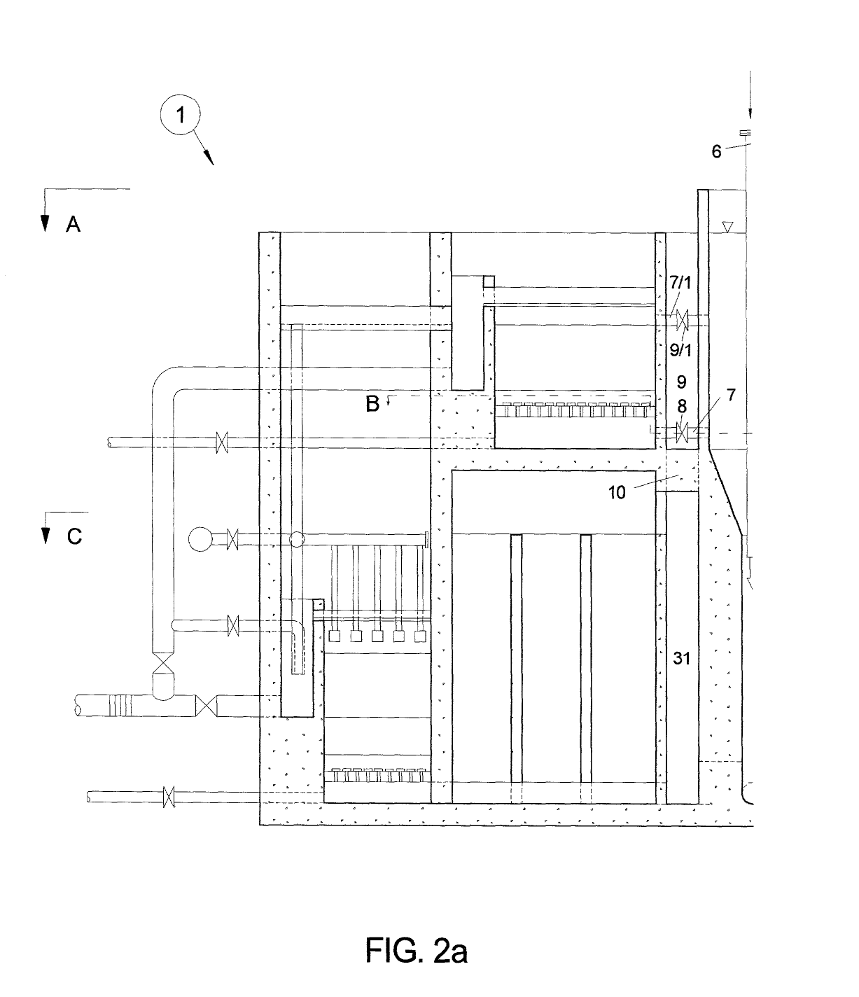

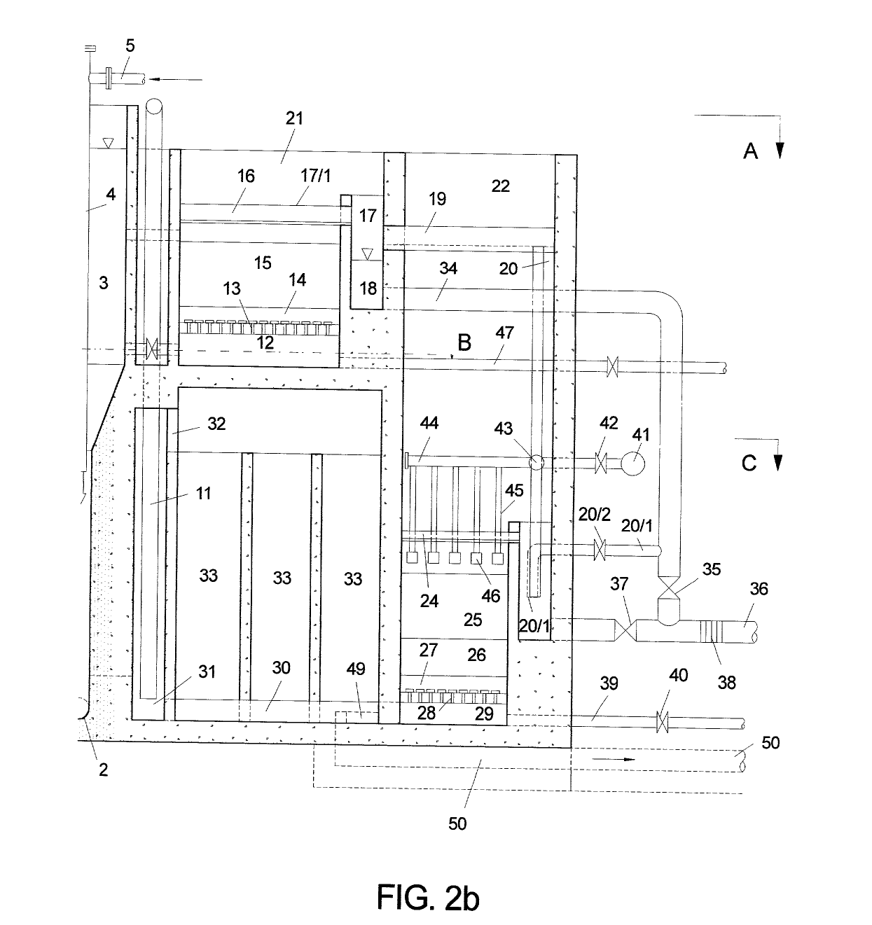

FIG. 1 shows the plan of water treatment plant with two-stage filtration 1 as a compact and optimal solution. Flash mixer 3 and 4, six roughing filters 21, six high-rate dual media filters 22 and clearwell 33 are integrated into one block—as water treatment plant with two—stage filtration. By main transmission influent pipeline 2, raw water is carried out into two-stage filtration plant 1. Raw water by pipe 2 is conveyed to flash mixer 3, 4. Based on countercurrent principle, the hydrodynamical dispersive flash mixer 4 by pressured water jets, with seven nozzles, six for hydrodynamical dispersion of coagulant and one for injection of chemical solution (alum), should be installed in unit 3 of flash mixing, from which coagulated water is discharge to roughing filters 21; into plenum 12 (see FIG. 2). The direction of filtration in roughing filters 21 is upward flow. Filtered water for roughing filters 21 discharges first in channel 17 and than to channel 19. Filtered water from channel 19 is discharged in inlet structure 23 of high-rate dual media filter (see also FIG. 2) by pipe 20. Filtered water in second-stage of filtration (high-rate dual media filters) 22, where direction of filtration is downward flow, is discharged to hydraulic structure 31, with overflow weir 32 (see FIG. 2), by pipe 30. Through weir 32 (see FIG. 2), filtered water is discharged into clearwell 33. Filtered water in second-stage of filtration is foreseen to be disinfected in clearwell 33 and by pipe 50 is conveyed to pumping station for distribution of drinking water. Waste washwater from first and second stage of filtration is foreseen to discharge through pipes 34 and 36. In pipe 36 is also foreseen to install a flow meter 38 to check the rates of backwashing for roughing filters 21 and high-rate dual media filters 22. The filters of second stage of filtration 22 are self-backwashing filters and the granular media is backwashed by filtered water, which is conveyed by pipe 30. For filters 22, up-flow waterwash is combined with surface wash. From pumping station is branched pipe 41/1 to supply with filtered water pipes 41, 43 and 44 to realize surface washing. For roughing filters 21 should be used raw water backwash from unit 3 simultaneously with air scour. In FIG. 1 is shown also pipe 2/1 and isolation valve 2/2 needed for maintenance of plant.

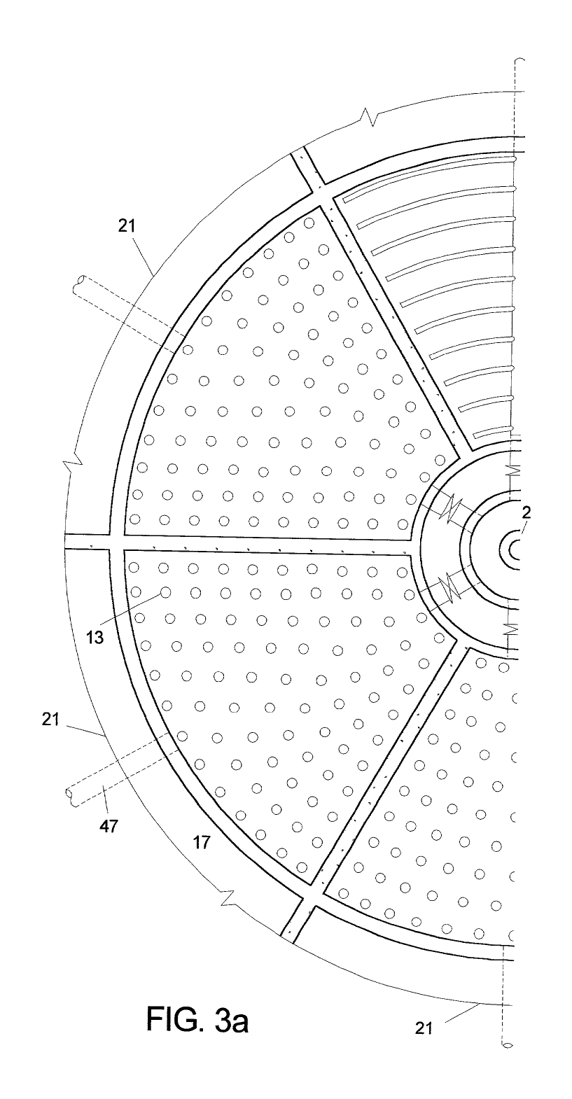

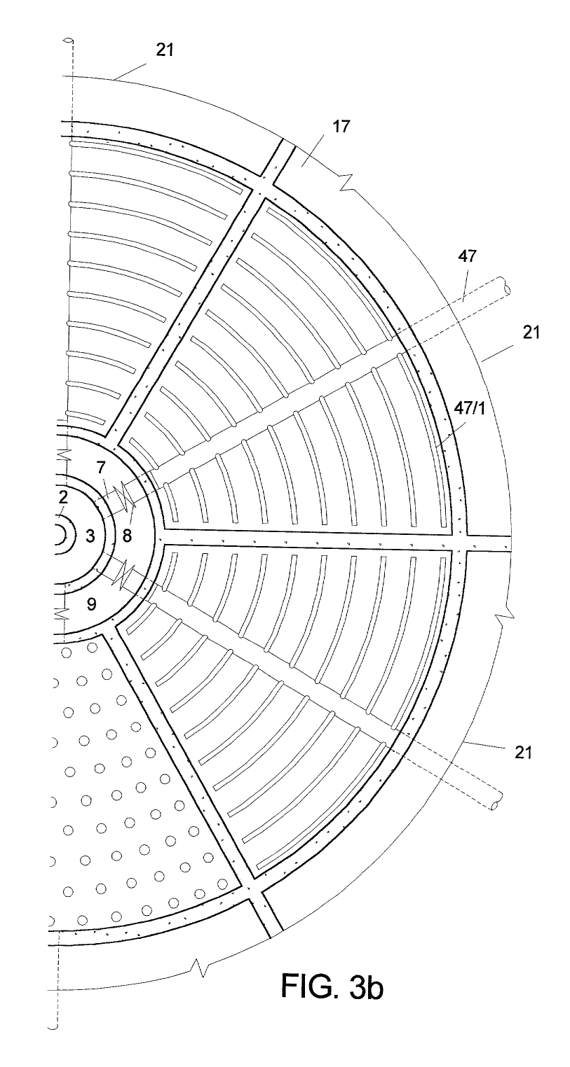

FIG. 2 shows the cross-section of FIG. 1 through A-A. Raw water is conveyed to water treatment plant 1 by influent pipe 2, which discharges raw water into flash mixing unit 3. Based on countercurrent principle the hydrodynamical dispersive flash mixer 4 by pressured water jets, with seven nozzles, six for hydrodynamical dispersion of coagulant and one for injection of chemical solution (alum), should be installed in unit 3 of flash mixing. Pipe 5 is branched from pumping station with filtered water and pipe 6 schematically shows the pipe of chemical solution. Coagulated water, from unit 3, is conveyed into plenum 12 of roughing filter 21 by pipe 7, in which is installed a control valve 8. Based on flow rate of water treatment plant with two-stage of filtration coagulated water from unit 3 can be conveyed to plenum 12 of roughing filter 21 by a channel (closed section) in which will be installed a slide gate. From plenum 12, coagulated water goes through underdrain system 13, gravel layers 14 and granular media 15 as an upward flow. Washwater troughs 16 are shown as a second alternative. For this water treatment plant, it is not recommended to use washwater troughs 16. Filtered water in roughing filter 21 will overflow from weir 17/1 into channel 17, and than to channel 19. From channel 19, filtered water in roughing filters 21 will be discharged into channel 23 of high-rate dual media filter 22 by pipe 20. Filtered water from roughing filters 21 will be filtered for second time in high-rate dual media filter 22, going through anthracite coal top layer 25, and silica sand bottom layer 26. Filtered water collected by underdrain system 28, from plenum 29 is conveyed to hydraulic structure 31 by effluent pipe 30. From 31, filtered water is discharged to clearwell 33, through weir 32. Disinfected water in clearwell 33 is conveyed to pumping station by hydraulic structures 49 and 50. For cleaning process, the deep coarse silica sand filters (roughing filters) should use raw water backwash simultaneously with air scour. The raw water for backwash from unit 3 to plenum 12 will be conveyed by pipe 7, in which is installed a control valve 8. To help backwashing process also is foreseen pipe 7/1 and control valve 8/1 on the top of granular media 15. The air will be supplied through pipe 47 and laterals 47/1 (see FIG. 3). Waste washwater will be discharged to channel 17 by weir 17/1, along vertical wall. In channel 17 will be established required water level 18 to discharge waste washwater by pipe 34. Conceptually, roughing filters, as well, during backwashing process are foreseen to operate as self-backwashing filters. The high rate dual media filters 22 will be backwashed with filtered water conveyed by pipe 30 from hydraulic structure 31 to plenum 29. Waste washwater is collected by washwater through 24 and discharged to channel 23. From 23, waste washwater is discharged with pipe 36. The rate of backwashing for two-stage filtration is controlled by control valves 35, 37, and flow meters 38. Pipes 39 with isolation valve 40 are foreseen to empty filter 22, after slide gate 30/1 (see FIG. 1) and control valves 8, 8/1 are closed. Surface washing of filters 22 is foreseen to be done by system composed with pipes 41, 43, 44, 45 and surface washing device 46 with eight nozzles and four orifices is an optimal system for efficient washing of 1 m²(10.75 ft²) of filter area.

The second alternative, to convey filtered water from roughing filters 21 to high-rate dual media filters 22, is by installing pipe 20/1 and control valve 20/2, instead of trough 19 and pipe 20.

FIG. 3 shows a cross-section of FIG. 2 through B-B. For three roughing filters 21 is shown distribution system of air supplied by pipe 47 and laterals 47/1. For three other roughing filters 21, is shown the position of nozzles 13 in false bottom

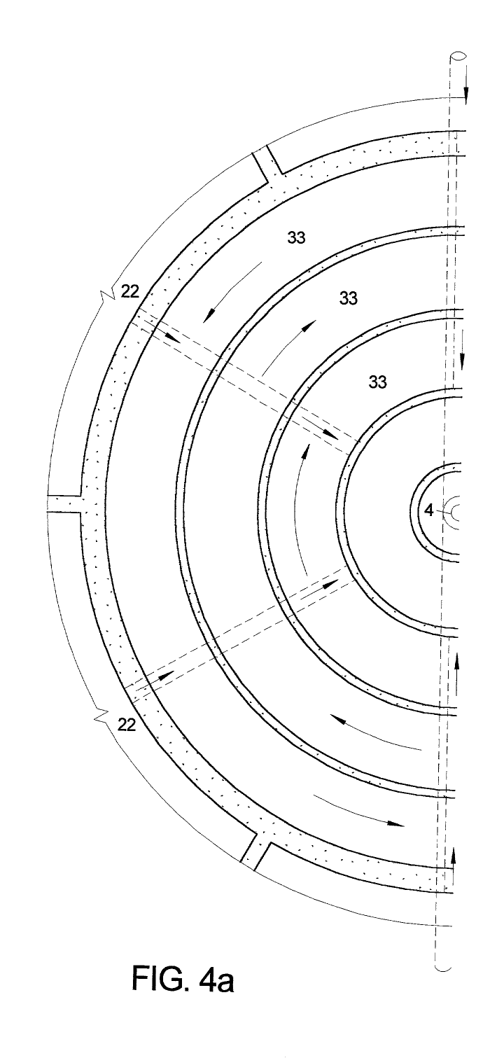

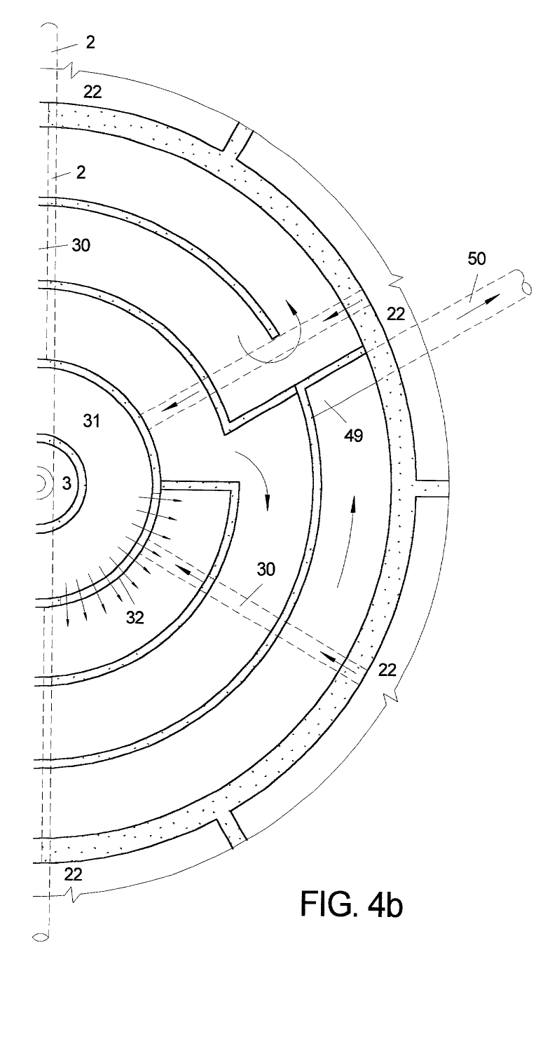

FIG. 4 shows a cross-section of FIG. 2 through C-C. From high rates dual media filters 22, filtered water is discharged to hydraulic structure 31 by pipe 30. Through weir 32, filtered water is discharged to the first compartment of clearwell 33 and than water goes around through other compartments of 33 to realize a plug flow up to hydraulic structure 49, from which filtered water is conveyed to pumping station by pipe 50. In FIG. 2 is shown also pipe 11, which is branched from pumping station, to supply in some instances with filtered water hydraulic structure 31, during cleaning process of filters.

What I claim as my invention is:

1. A water treatment plant with two-stage filtration, conceptually original, with flow rate up to 2 m³/sec (≈46 mgd), efficiently purifying surface waters with turbidity less than 100 NTU, color less than 75 UC, coliform less than 20,000 per 100 m, algae less than 2,000 ASU/mL, TOC less than 4 mg/L and odor less than 5 TON, alkalinity less than 200 mg/L, hardness less than 150 mg/L.

2. A water treatment plant as defined in claim 1, wherein:
said roughing filters of the first stage and high rate dual media filters of the second stage are conceptually self-backwashing filters in which backwashing rate is controlled into waste wash water pipe;
said roughing filters as a contact flocculator/contact clarifier operate with or without pre-flocculation;
said the changes of temperature and flow rate are maintained hydraulically under control;
said flash mixer, six roughing filters, six high rate filters and a clearwell are integrated in one block as an optimal, reliable, and effective solution.

3. A water treatment plant as defined in claim 1 and claim 2, said to be also very efficient for raw waters with low temperature.
